(19) United States
(12) Patent Application Publication
(10) Pub. No.: US 2015/0060345 A1
(43) Pub. Date: Mar. 5, 2015

(54) FILTERING APPARATUS

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: QI-LIN BO, Shenzhen (CN); MING-CHANG LEE, New Taipei (TW)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/252,451

(22) Filed: Apr. 14, 2014

(30) Foreign Application Priority Data
Aug. 29, 2013 (CN) 2013103835978

(51) Int. Cl. B01D 35/30; B01D 35/02; B01D 29/05

(52) U.S. Cl. CPC B01D 35/30; B01D 29/05; B01D 35/02
USPC 210/236; 210/232

(57) ABSTRACT

A filtering apparatus includes a bracket, a filter, a number of pressing members, and a fastening member. An inner of the bracket defines an installing recess. The filter is made of flexible material. The filter includes a bottom plate, a number of side plates extending up from a circumference of the bottom plate, and a flange protruding out from a circumference of the side plates. The fastening member defines a receiving slot. The filter is received in the bracket, the pressing members are placed on the bottom plate, and the pressing members are pressed to latch in the installing recess of the bracket. The flange is placed on top of the bracket, the fastening member is detachably covered on the bracket. The flange is received in the receiving slot of the fastening member.

### FIELD

The present disclosure relates to a filtering apparatus.

### BACKGROUND

Cutting fluid is used in machine work. The cutting fluid usually is filtered by a conventional filtering apparatus. The conventional filtering apparatus includes a filter mounted in the filtering apparatus by welding or riveting.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a filtering apparatus, wherein the filtering apparatus includes a plurality of pressing members and a fastening member.

FIG. 2 is an enlarged view of a circled portion II of FIG. 1.

FIG. 3 is an enlarged, isometric view of one of the pressing members of FIG. 1.

FIG. 4 is a partial, enlarged view of the fastening member of FIG. 1.

FIG. 5 is an assembled, isometric view of the filtering apparatus of FIG. 1.

FIG. 6 is a cross-sectional view of FIG. 5, taken along line VI-VI.

FIG. 7 is a partial, enlarged view of FIG. 6.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

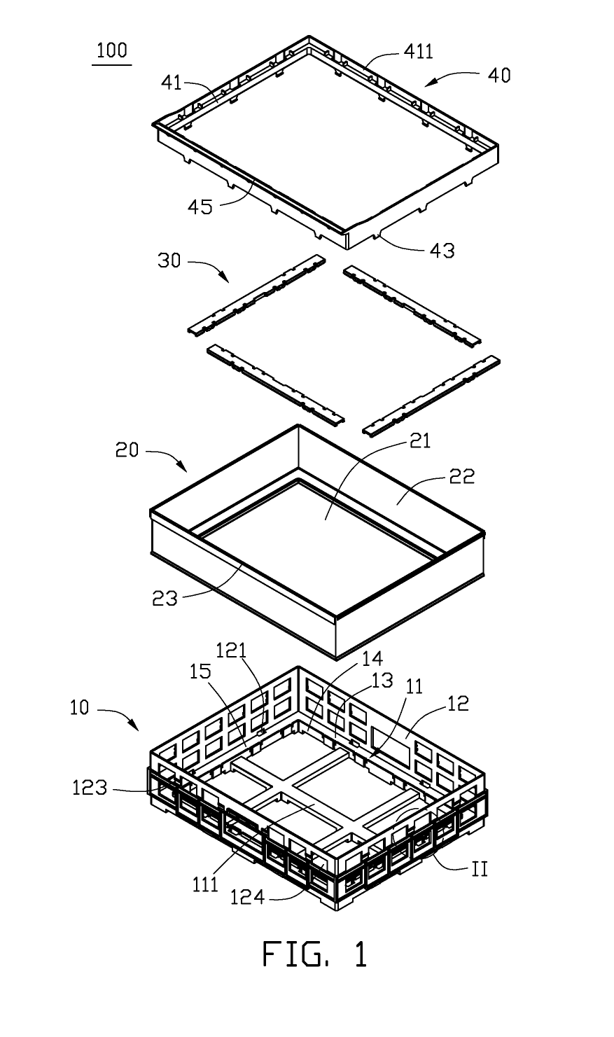

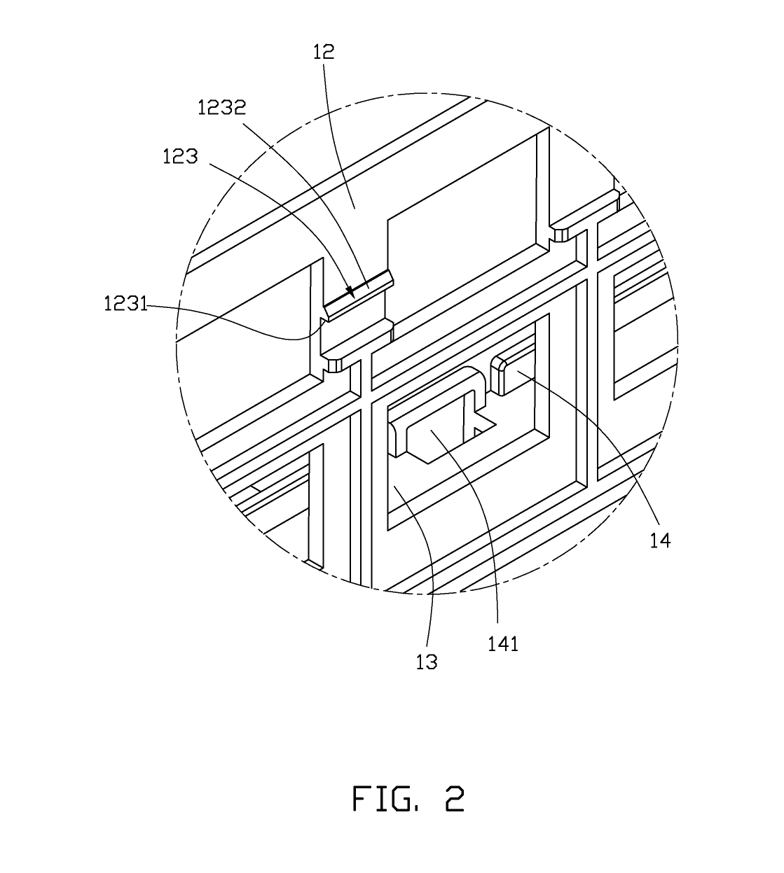

FIGS. 1 and 2 illustrate an embodiment of a filtering apparatus 100 comprising a bracket 10, a substantially rectangular filter 20, four pressing members 30, and a substantially rectangular fastening member 40.

The bracket 10 comprises a substantially rectangular bottom frame 11 and four side walls 12 perpendicularly extending up from four sides of the bottom frame 11. The bottom frame 11 comprises four supporting plates 13 perpendicularly extending inward from bottom sides of the side walls 12 and four positioning plates 14 perpendicularly extending up from distal sides of the supporting plates 13 away from the side walls 12. The side walls 12, the supporting plates 13, and the positioning plates 14 cooperatively bound an annular installing recess 15. A junction of each side wall 12 and the corresponding supporting plate 13 defines a plurality of latching holes 121. A junction of each supporting plate 13 and the corresponding positioning plate 14 defines a plurality of fastening holes 141. A plurality of locking blocks 123 protrudes out from an upper portion of an outer surface of each side wall 12. Each locking block 123 comprises a locking surface 1231 formed on a bottom of the locking block 123, and a guiding surface 1232 formed on a top of the locking block 123. A plurality of ribs 111 can be connected between the positioning plates 14. Each side wall 12 defines a plurality of through holes 124 for allowing cutting fluid to flow through.

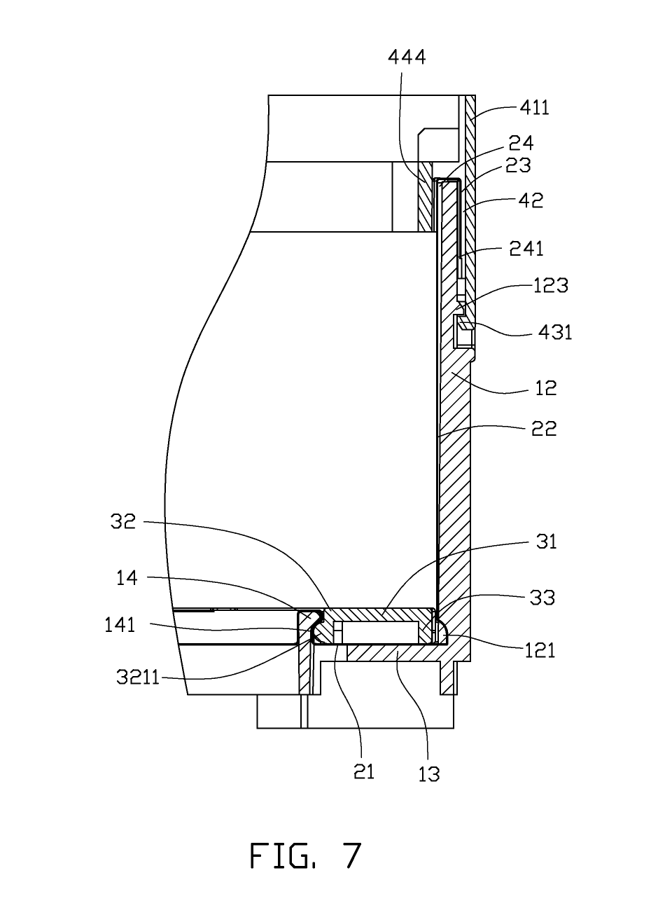

The filter 20 is made of flexible material, such as pliable wire netting. The filter 20 comprises a substantially rectangular bottom plate 21, four side plates 22 perpendicularly extending up from four sides of the bottom plate 21, and four L-shaped flanges 23 extending out from top sides of the side plates 22. Each flange 23 and the corresponding side plate 22 cooperatively bound a latching slot 24 with an opening 241 (shown in FIG. 7) adjacent to the bottom plate 21. The bottom plate 21 and the side plates 22 define a plurality of filtering holes (not shown).

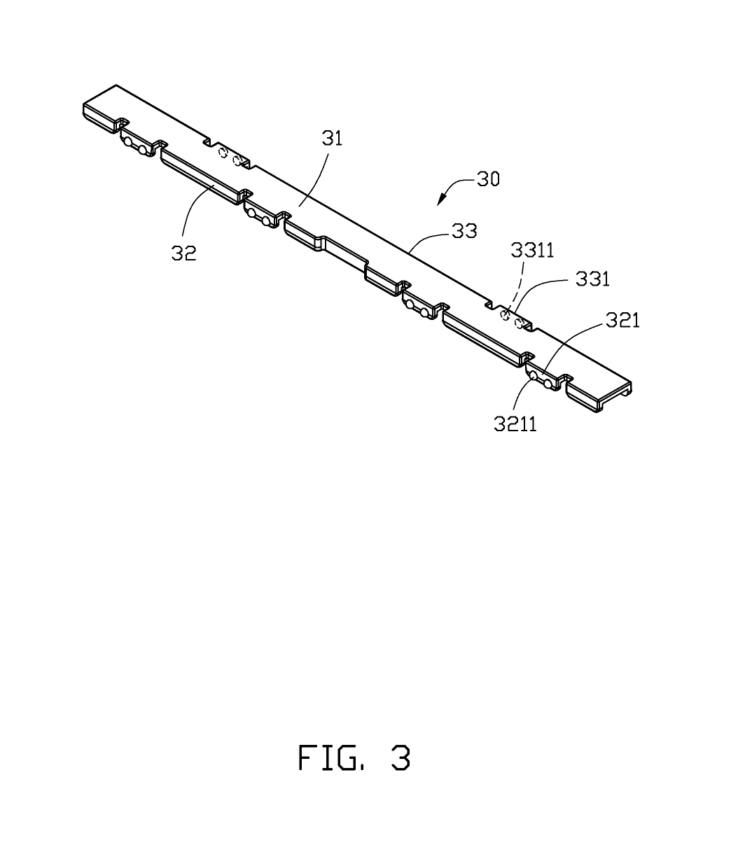

FIG. 3 shows one of the pressing members 30, which comprises a substantially rectangular pressing plate 31, a first bar 32 extending perpendicularly downward from a first side of the pressing plate 31, and a second bar 33 extending perpendicularly downward from a second side of the pressing plate 31 opposite to the first bar 32. The first bar 32 comprises a plurality of resilient fastening portions 321. The second bar 33 comprises a plurality of resilient latching portions 331. Two hemispherical protrusions 3211 protrude from each fastening portion 321, and two hemispherical protrusions 3311 protrude from each latching portion 331.

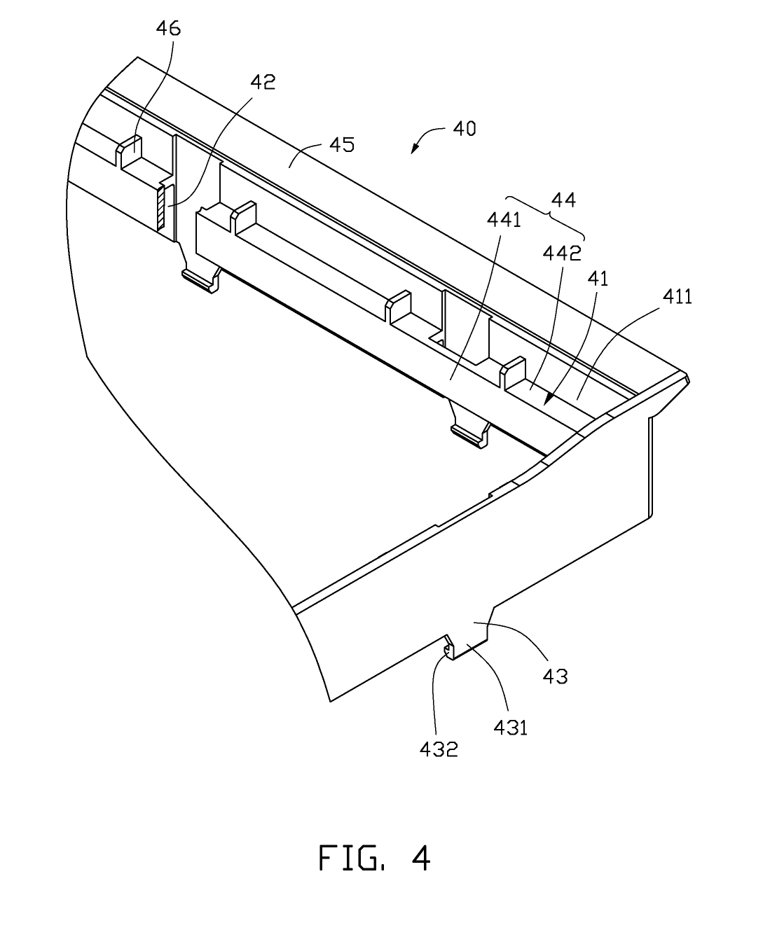

FIGS. 1 and 4 illustrate the fastening member 40, which comprises a shell 41.

The shell 41 comprises four side plates 411 connected end to end and four fastening portions 44 having L-shaped cross-sections protruding inward from inner surfaces of the side plates 411. Each fastening portion 44 comprises a top plate 442 perpendicularly extending inward from the corresponding side plate 411 and an extending plate 441 perpendicularly extending down from a distal side of the top plate 442. Each fastening portion 44 and the corresponding side plate 411 cooperatively bound a receiving slot 42. A plurality of ribs 46 is connected between the side plate 411 and a top of the corresponding top plate 442. A plurality of resilient hooks 43 extends downward from a bottom of each side plate 411. Each hook 43 comprises a resilient extending portion 431 and a latching portion 432 protruding inward from a bottom end of the extending portion 431. Four guiding plates 45 extend slantingly from tops of the side plates 411, for guiding the cutting fluid.

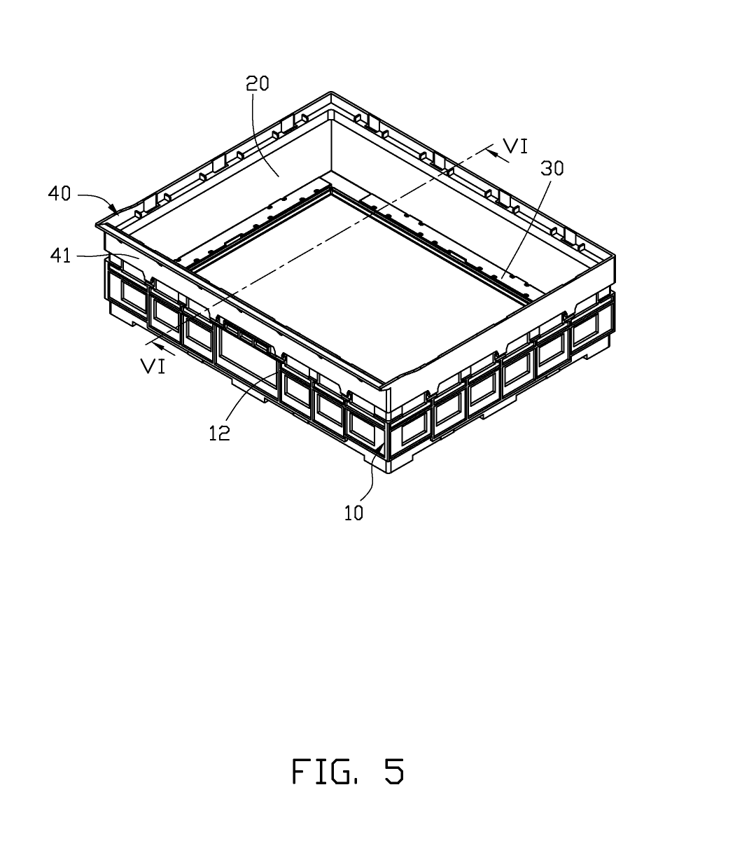

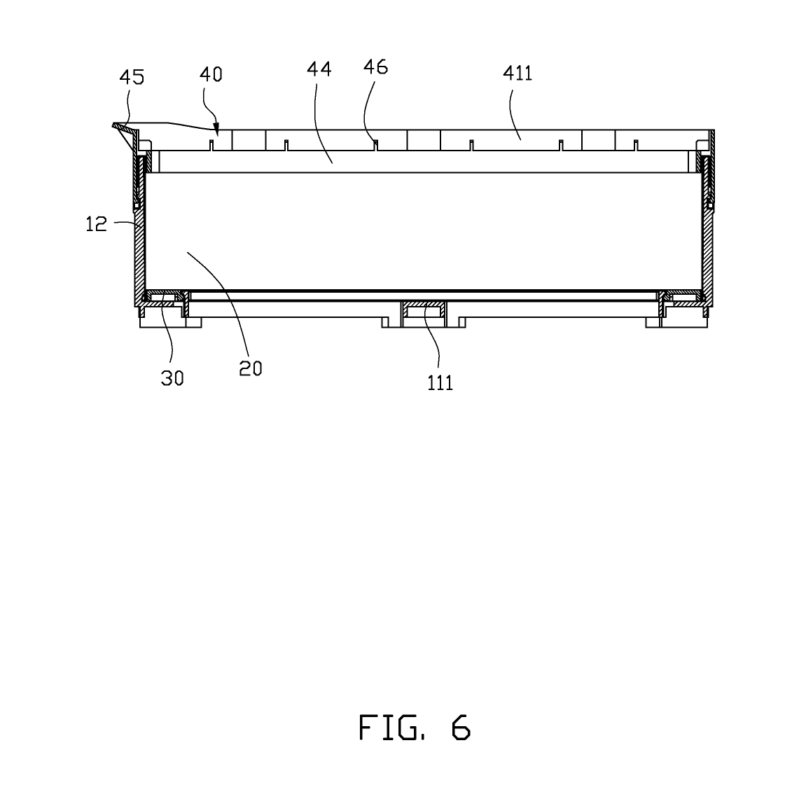

FIGS. 5-7 illustrate an assembled filtering apparatus 100. As illustrated, the filter 20 is received in the bracket 10 with the bottom plate 21 being deformed and supported on the supporting plates 13 and the ribs 111. The side plates 22 of the filter 20 engage with inner surfaces of the side walls 12. The pressing members 30 are placed on the bottom plate 21, and pressed in the installing recess 15. The protrusions 3211 of the fastening portions 321 of each pressing member 30 are latched in the corresponding fastening holes 141 of the bracket 10, and the protrusions 3311 of the latching portions 331 of each pressing member 30 are latched in the corresponding latching holes 121 of the bracket 10. Four edges of the bottom plate 21 of the filter 20 are sandwiched between the supporting plates 13 and the pressing members 30.

Tops of the side walls 12 are inserted in the latching slots 24 of the filter 20 from the corresponding openings 241. The fastening member 40 is covered on the filter 20, and the tops of the filter 20 and the side walls 12 are inserted in the corresponding receiving slots 42 of the fastening member 40. The fastening member 40 is pressed toward the bracket 10. The latching portions 432 of the hooks 43 slidably abuts against the guiding surfaces 1232 of the corresponding locking blocks 123, to deform the extending portions 431, until each latching portion 432 crosses through the corresponding locking block 123. The extending portions 431 are restored to bias the latching portions 432 to engage with the locking surfaces 1231. The flanges 23 of the filter 20 are sandwiched between the side walls 12 and the fastening portions 44 of the fastening member 40.

To detach the filter 20, each hook 43 is pulled away from the corresponding side wall 12, deforming the extending portions 431, until the hooks 43 are detached from the locking blocks 123. The fastening member 40 is detached from the bracket 10. Each pressing member 30 is pulled away from the bottom frame 11, deforming the fastening portions 321 and the latching portions 331, until the pressing members 30 are detached from the installing recess 15. It is convenient to disassemble the filter 20 from the bracket 10.

The filter 20 is installed by the pressing members 30 and the fastening member 40 is detachably latched to the bracket 10, so it is convenient to assemble or disassemble the filter 20.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A filtering apparatus, comprising:
a bracket defining an installing recess in an inner of the bracket;
a filter made of flexible material, and comprising a bottom plate, a first side plate extending up from a circumference of the bottom plate, and a flange protruding out from a circumference of the first side plates;
a plurality of pressing members; and
a fastening member defining a receiving slot;
wherein the filter is received in the bracket, the pressing members are placed on the bottom plate of the filter, the pressing members are pressed to detachably latch in the installing recess of the bracket, the bottom plate of the filter is sandwiched between the bracket and the pressing members, the flange is placed on a top of the bracket, the fastening member is detachably connected to the bracket, the flange is received in the receiving slot of the fastening member.

2. The filtering apparatus of claim 1, wherein the bracket comprises a bottom frame and a side wall extending up from a circumference of the bottom frame, the bottom frame comprises a supporting plate extending inward from a bottom of the side wall, and a positioning plate extending up from a distal side of the supporting plate, the installing recess is bounded by the side wall, the supporting plate, and the positioning plate.

3. The filtering apparatus of claim 2, wherein a junction of the side wall and the supporting plate defines a plurality of latching holes, a junction of the supporting plate and the positioning plate defines a plurality of fastening holes, each pressing member comprises a plurality of resilient latching portions detachably latched in the corresponding latching holes and a plurality of resilient fastening portions detachably latched in the corresponding fastening holes.

4. The filtering apparatus of claim 3, wherein each pressing member comprises a pressing plate received in the installing recess, a first bar extending down from a first side of the pressing plate, and a second bar extending down from a second side of the pressing plate, the fastening portions are formed on the first bar, and the latching portions are formed on the second bar.

5. The filtering apparatus of claim 2, wherein the bottom frame further comprises a plurality of first ribs mounted to the positioning plate, for supporting the bottom plate of the filter.

6. The filtering apparatus of claim 2, wherein the side wall defines a plurality of through holes.

7. The filtering apparatus of claim 2, wherein a plurality of locking blocks protrudes out from the side wall, the fastening member further comprises a plurality of resilient hooks detachably latched to the corresponding locking blocks of the bracket.

8. The filtering apparatus of claim 2, wherein the flange of the filter is L-shaped, the flange and the first side plate bound a latching slot, a top of the side wall is received in the latching slot, and the top of the side wall is latched in the receiving slot of the fastening member, the flange is sandwiched between the side wall and the fastening member.

9. The filtering apparatus of claim 8, wherein the fastening member comprises a plurality of second side plates connected end to end, and a plurality of fastening portions protruding inward from inner surfaces of the second side plates, each fastening portion comprises a top plate extending inward from the corresponding second side plate and an extending plate extending down form a distal side of the top plate, the second side plates, the top plates, and the extending plates cooperatively bound the receiving slot, and the hooks extend down from a bottom of the second side plates.

10. The filtering apparatus of claim 9, wherein a plurality of guiding plates extend slantingly out from tops of the second side plates for guiding cutting fluid.

11. The filtering apparatus of claim 9, wherein a plurality of second ribs is connected between the second side plate and a top of the corresponding top plate.
